(19) United States
(12) Patent Application Publication
(10) Pub. No.: US 2011/0165280 A1
(43) Pub. Date: Jul. 7, 2011

(54) METHOD TO ACCURATELY CONTROL SIZE, VELOCITY, AND RELATIVE POSITION SETS OF RECLOSABLE MECHANISM

(75) Inventors: Roy KOSUB, Seguin, TX (US); Victor MATIAS, New Braunfels, TX (US)

(73) Assignee: ILLINOIS TOOL WORK INC., Glenview, IL (US)

(21) Appl. No.: 13/048,143

(22) Filed: Mar. 15, 2011

Related U.S. Application Data
(63) Continuation of application No. 12/218,418, filed on Jul. 15, 2008.

(51) Int. Cl. B29C 47/12

(52) U.S. Cl. 425/224

(57) ABSTRACT

The apparatus includes an extrusion die and further includes a main or primary extruder for the supply of material, such as low density polyethylene, to form the tubing for the manufacture of reclosable packages, bags or pouches. The apparatus further includes at least one secondary extruder, or co-extruder, for the extruding of each reclosable profile onto the tubing. The speed of the co-extruders is controlled so as to control the extrusion of the reclosable profiles.

This application claims priority under 35 U.S.C. §119(e) of provisional application Ser. No. 60/961,752, filed on Jul. 24, 2007.

### BACKGROUND OF THE INVENTION

1. Field of the Invention

The present invention relates to a manufacturing method to control the size velocity and relative position of a reclosable mechanism or multiple reclosable mechanisms, such as a zipper or zippers on a flexible plastic film, bag or pouch.

2. Description of the Prior Art

In the prior art of the manufacture of zippers and similar devices for reclosable plastic film, bags or pouches, the velocity of the delivery of the resin to the profiles or to the locking elements could not be accurately controlled by such elements as a choke device. This inability to accurately control the resin velocity made it difficult to extrude complex locking mechanisms at a reasonable cost and production rate.

Further prior art includes methods where the zipper tape is extruded, wound and then, in a secondary process, unwound, heated and attached to the film. Still further prior art may be found in published patent application US2005/0269733 A1 entitled “Method of and Apparatus for Forming Multiple Closure Elements”.

### OBJECTS AND SUMMARY OF THE INVENTION

It is therefore an object of the present invention to provide a method and apparatus for the manufacture of complex locking mechanisms for reclosable interlocking elements, such as a zipper profile on a flexible film plastic package, bag or pouch, at a reasonable cost and production rate.

It is therefore a further object of the present invention to provide accurate control of the velocity of the resin flow delivered to the profile at its point of juncture with the film or tubing of the reclosable plastic package, bag or pouch.

It is therefore a still further object of the present invention to improve adhesion of closure elements to the body of the package, bag or pouch by preventing exposure of the contact surfaces.

These and other objects are attained by cooling the integral profile tubing and drawing it in a negative ratio whereby the circumference of the cooled and drawn finished tubing is less than the circumference of the die plate. The resin for the profile interlocking elements is delivered from a co-extruder through a separate channel, or several separate channels, to the die body and thence to the die plate, where the resin is joined to the film (tubing) at a controlled rate, with the control being the speed of the co-extruder drive.

### DESCRIPTION OF THE DRAWINGS

Further objects and advantages of the invention will become apparent from the following description and claims, and from the accompanying drawings, wherein:

FIG. 1 is a schematic of the apparatus of the present invention.

FIGS. 2a-2i are examples of zipper profiles which can be produced by the apparatus of the present invention.

### DETAILED DESCRIPTION OF THE PREFERRED EMBODIMENT

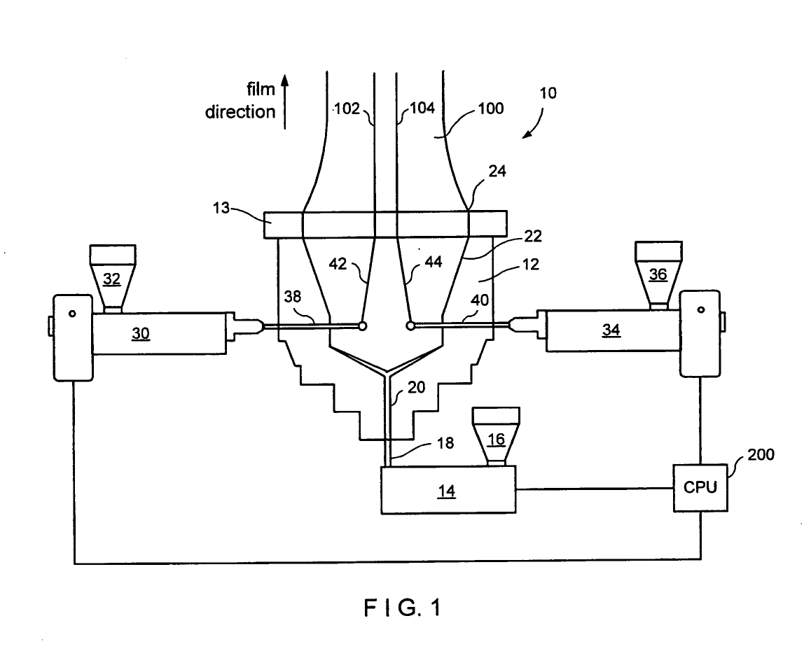

Referring now to the drawings in detail, wherein like numerals indicate like elements throughout the several views, one sees that FIG. 1 is a schematic of the apparatus 10 of the present invention. Extrusion die body 12 receives the material for the formation of the tubing (e.g. a tube or a film), such as, but not limited to, low density polyethylene, from primary extruder 14 and extruder material hopper 16 via supply channel 18. Supply channel 18 joins extrusion die body primary supply channel 20 which is formed within extrusion die body 12. Extrusion die body primary supply channel 20, in turns, feeds the material for the tubing to the extrusion die cavity 22 where the tube or film 100 is formed. Tube or film 100, typically in a cylindrical shape, exits from the mouth 24 of extrusion die plate 13, and therefore may be referred to as tubing (or as a low density polyethylene bubble). The tubing is typically drawn into a negative ratio and cooled. That is, due to the speed of the film and related factors, the circumference of the cooled and drawn finished tubing 100 is typically less than the circumference of the extrusion die plate 13, but in some applications may be the same size or even greater than the circumference of the extrusion die plate 13.

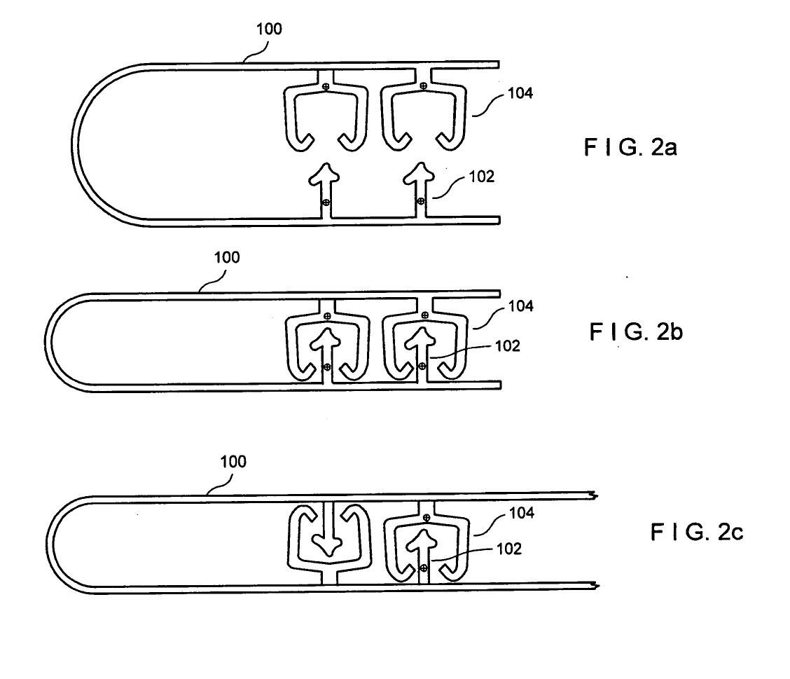

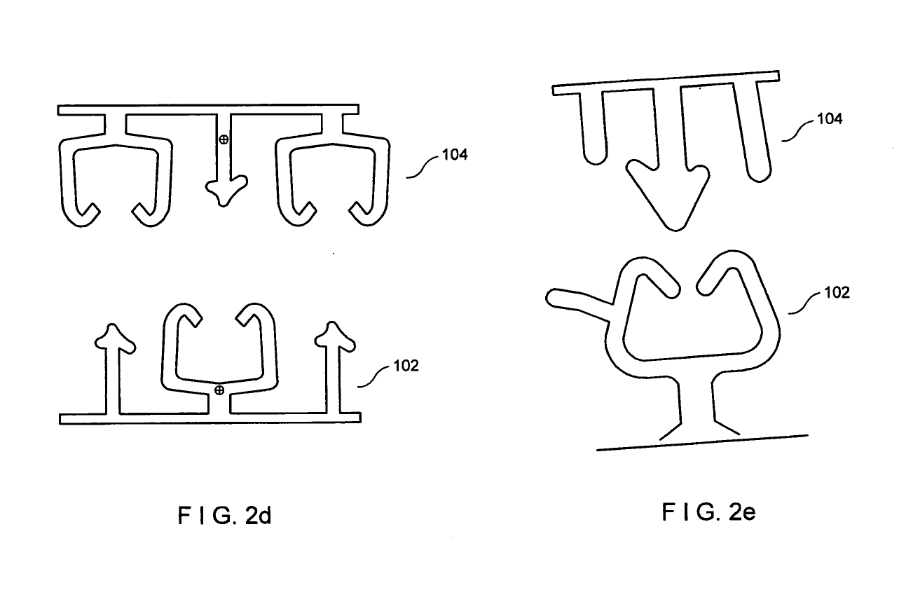

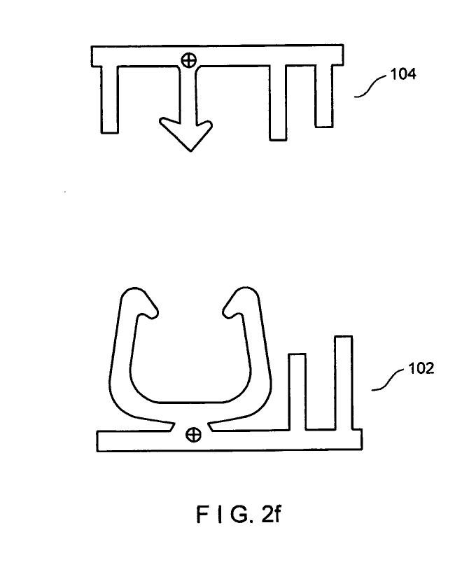

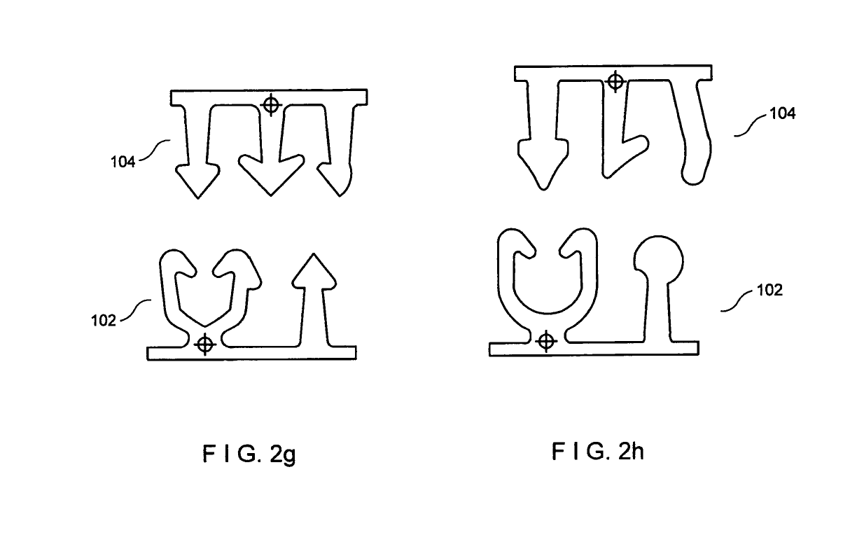

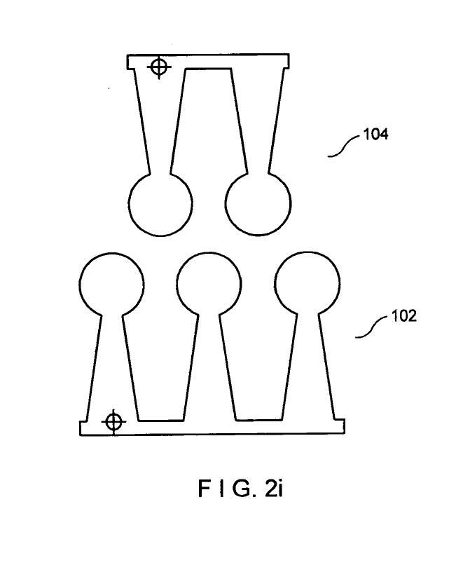

Secondary extruders 30, 34 include respective secondary extruder material hoppers 32, 36 supplying material, such as resin (which may be colored or uncolored), for the formation of the reclosable profiles. The use of colored resin allows the user to see and handle the profiles more easily. The resin, or similar material, may be the same in secondary extruders 30, 34 or may be different (including such characteristics as color). It is envisioned, however, that the primary extruder 14 would supply a flexible, soft and pliable material while the secondary extruders 30, 34 would supply a more rigid, robust material for forming reclosable profiles 102, 104. The resin, or similar material, is provided via respective secondary supply channels 38, 40 (typically implemented as heated hoses) and respective secondary die body supply channels 42, 44 to the die plate, where it is joined to the tubing 100 at a controlled rate (as well as a controlled temperature), with the control being the speed of the drive of the secondary extruders 30, 34, thereby forming reclosable profiles 102, 104 on tubing 100. The resin (or other material) from the secondary extruders 30, 34 for forming the reclosable profiles 102, 104 does not come into contact with the material (tube or film 100) from the primary extruder 14 until it reaches the extrusion die plate 13 typically approximately one half inch (although other distances are envisioned) before both exit the extrusion die body 12. The control of the speed of the drive of the secondary extruders 30, 34 and or control of the temperature of the resin or similar material provided to the secondary supply channels 38, 40 (is, in turn, typically controlled by CPU 200 or a similar processing device) thereby provides the ability to extrude more complex shapes of the interlocking elements than was previously possible. Additionally, it is envisioned that as many as nine, or even more, secondary extruders may be used, with respective material supplies and secondary supply channels to form the various complex shapes. FIGS. 2a-2i are representative of a sample of the many profile shapes that are possible with various embodiments of the present invention which, applicant believes, have been difficult, if not impossible, to obtain with the prior art, particularly with respect to multiple interlocking elements formed on a single profile.

The resulting configuration typically has many or all of the following advantages:

1. the velocity and speed of the resin for the locking mechanism is controlled separately from that of the tubing;

2. the velocity of the resin for the interlocking elements is controlled accurately and separately from that of the tubing;

3. the distance between sets of profiles is controlled;

4. more complex locking mechanisms may be manufactured;

5. the cooling rate of the interlocking elements is accurately controlled;

6. more complex multiple interlocking elements are possible;

7. interlocking elements with separators between the interlocking elements can be provided;

8. the shapes, construction and structural characteristics of the interlocking elements are controlled, including profiles with multiple interlocking elements;

9. the tubing may have two or more sets of profiles, each set provided with separate sources of profile control;

10. the separate resin source can be a co-extruder (or secondary extruder);

11. the profiles are provided with multiple interlocking elements;

12. a co-extruder (or secondary extruder) can provide resin flows to several sets of profiles or a separate co-extruder (or secondary extruder) can be used for each resin flow;

13. the flow of resin to the profiles can be controlled, so that the profiles cool at a controlled rate; and

14. the speed of the profile extrusion can be controlled so that the speed of the profile extrusion and the speed of the film extrusion are equal when the profile and the film come into contact with each other.

Thus the several aforementioned objects and advantages are most effectively attained. Although preferred embodiments of the invention have been disclosed and described in detail herein, it should be understood that this invention is in no sense limited thereby and its scope is to be determined by that of the appended claims.

1-30. (canceled)

31. A die plate including a cylindrical shape for forming a tube, supplied with material from a primary extruder, the die plate including means for forming reclosable profiles joined to the tube supplied with a material from a secondary extruder, wherein the profiles have three or more adjacent interlocking elements.

32. The die plate of claim 31, wherein the material of the primary and secondary extruders is joined below the surface of the die plate.

33. The die plate of claim 31, wherein the profiles include two adjacent sets of closely adjacent interlocking elements.

34. The die plate of claim 33, wherein each set of interlocking elements includes a male and a female interlocking element.

35. The die plate of claim 33, wherein one set of interlocking elements includes two male elements and the other set of interlocking elements includes two female elements.

36. The die plate of claim 33, wherein a distance between the interlocking elements within one set is less than the distance between the adjacent sets of interlocking elements.

37. The die plate of claim 31 wherein each set of interlocking elements includes at least two male elements.

38. The die plate of claim 31 wherein the adjacent sets of interlocking elements do not interlock with each other.

39. A die plate for forming a tube, supplied with material from a first extruder, the die plate including means for forming profiles joined to the tube supplied with a material from a second extruder, wherein the profiles have three or more adjacent interlocking elements.

40. The die plate of claim 39, wherein the material of the first and second extruders is joined below the surface of the die plate.

41. The die plate of claim 39, wherein the profiles include two adjacent sets of closely adjacent interlocking elements.

42. The die plate of claim 41, wherein each set of interlocking elements includes a male and a female interlocking element.

43. The die plate of claim 41, wherein one set of interlocking elements includes two male elements and the other set of interlocking elements includes two female elements.

44. The die plate of claim 41, wherein a distance between the interlocking elements within one set is less than the distance between the adjacent sets of interlocking elements.

45. The die plate of claim 39 wherein each set of interlocking elements includes at least two male elements.

46. The die plate of claim 39 wherein the adjacent sets of interlocking elements do not interlock with each other.
